(19) United States
(12) Patent Application Publication
(10) Pub. No.: US 2002/0007705 A1
(43) Pub. Date: Jan. 24, 2002

(54) Multi-bit driver

(76) Inventor: Fern Beauchamp, St. Catharines (CA)

Correspondence Address: M. Koch, 866 Main St. E., Hamilton, ON, L8M 1L9, CA

(21) Appl. No.: 09/902,718

(22) Filed: Jul. 12, 2001

Related U.S. Application Data
(60) Provisional application No. 60/219,446, filed on Jul. 20, 2000.

(51) Int. Cl. B25G 1/08

(52) U.S. Cl. 81/490

(57) ABSTRACT

The present invention a multi-bit driver comprises a longitudinally oriented housing including a bit chuck at one end; a plurality of tool bits nested within said housing in a retracted position; and bit assemblies including tool bits and being operable to extend said tool bit from said retracted position to said extended position by a single longitudinal motion for selectively extending tool bits to an extended position and retracting said tool bits to said retracted position, such that in the extended position, said tool bits project from said bit chuck and are substantially longitudinally aligned with said housing.

### FIELD OF THE INVENTION

This invention relates to hand held implements having interchangeable objects which are captured within the implement and selected object extendable from the implement for use.

### BACKGROUND OF THE INVENTION

There are presently available on the market place, many forms of multi object and multi-bit devices. An example is in the multi-bit driver where several bits are contained within a hollow handle. When desired to use a particular bit, the handle rear portion is opened by unscrewing a cap for the handle and selecting the needed bit. The selected bit is then placed into a chuck at normally the other end of the handle for use. The disadvantage of this system is that often bits are lost for failure to return the used bit to the hollow handle and often the multi-bit drivers of this type are not used because of the awkwardness of installing and uninstalling bits which are required for particular application.

There are multi-bit drivers available which provide in one form or another arrangements which minimize or prevent loss of the driver bits. Examples of the prior are devices which have been patented are as follows:

U.S. Pat. Nos. 4,552,043, 4,552,044, 4,463,788, 4,716,795, 4,716,796, and 5,228,363, all of these patents filed under various titles by the same inventor, Corona et al and describing the hand held multi-bit implement. The Corona type multiple object implements require lowering into position a very long bit, sliding it laterally into position where it can be locked and then urging the bit into a locked position for use. There are a number of specific operations which must be carried out in order to bring the tool bits into operational position and then once again tool bit to its storage position. This type of multi-bit driver, however, does have the advantage that the tool bit cannot be easily lost, as they are non-removable from the handle at all times. The disadvantage of the Corona devices is that they are awkward to use and time consuming to bring the bits into and out of the operational position.

Other devices which have been patented and have attempted to solve the problem of an easy to use multi-bit driver are found in these following patents:

U.S. Pat. No. 5,881,615 by Todd Kevin Dahl issued Mar. 16, 1999 under the title Multiple Bit Drivers and Methods.

U.S. Pat. No. 5,442,982 by Dennis J. Bell issued Aug. 22, 1995 under the title Nesting Pocket Drivers.

U.S. Pat. No. 5,174,178 issued Dec. 29, 1992 by Horace C. Disston Jr., under the title Selective Tool Handle.

U.S. Pat. No. 4,924,733 issued May 15, 1990 invented by Archibald M. McKenzie under the title Multiple Bit Driver.

U.S. Pat. No. 5,265,504 issued Nov. 30, 1993 by Hermann Fruhm titled Cartridge Type Driver.

All of the above devices attempt to solve the problem of minimizing the loss of the tool bits but yet maintaining an easy to use multi-bit driver which minimizes the time for bringing a tool bit into and out of operation and also decreases the time for selecting one tool bit from another. The above patents all have the disadvantage that the number of operations and the time necessary for bringing the tool bit into operation is quite lengthy and often specially designed tools bits are necessary in order to make these multi-bit drivers functional.

There is a need for a multi-bit driver which is easily used which allows for a very quick selection of tool bits which prevents the loss of tool bits through misuse and provides for a rugged dependable design.

### SUMMARY OF THE INVENTION

The present invention multi-bit driver comprises:

(a) a longitudinally oriented housing including a bit chuck at one end;

(b) a plurality of tool bits nested within said housing in a retracted position; and

(c) an actuating means for selectively extending tool bits to an extended position and retracting said tool bits to said retracted position, such that in the extended position, said tool bits project from said bit chuck and are substantially longitudinally aligned with said housing.

Preferably wherein said actuating means including said tool bits and being operable to extend said tool bit from said retracted position to said extended position by a single longitudinal motion of said actuating means.

Preferably wherein said longitudinal motion is effected using a single finger or thumb pressure.

Preferably wherein said actuating means connected to said tool bits being operable to retract said tool bits from said extended position to said retracted position by a single longitudinal motion of said actuating means.

Preferably wherein said longitudinal motion is effected using a single finger or thumb pressure.

Preferably wherein said actuating means operates to extend said tool bit by longitudinal motion in one direction and retract said tool bit by longitudinal motion in the opposite direction.

Preferably wherein said longitudinal motion is effected using a single finger or thumb pressure.

Preferably wherein said actuator means further includes at least one bit assemblies having a flexible bit extension connected to each of said tool bits, said bit extensions for operatively urging said tool bits between said extended and retracted position and for aligning said tool bits with said bit chuck.

Preferably wherein said actuating means further includes at least one longitudinally aligned actuator channels defined in said housing corresponding to each bit assembly for guiding said bit assemblies slidably along a longitudinal direction.

Preferably further including a fastening means slidably connecting said bit assemblies to said actuator channels such that said bit assembly is guided slidably along said actuator channel.

Preferably wherein said fastening means comprises an actuator knob partially projecting externally of said housing for the application of finger pressure thereto, said actuator knob also for connecting a fastener end of said bit assembly to said actuator knob for operatively urging said bit assembly slidably along said actuator channel.

Preferably wherein said housing including a cone proximate said bit chuck having an interior guide surface for slidably guiding tool bits into alignment with said bit chuck as tool bits are urged into said extended position.

Preferably further including a guide means for maintaining said bit assemblies separate and nested proximate the inner surface of said housing, and for guiding said bit assemblies as they are urged between the extended and retracted position.

Preferably wherein said guide means includes permanent magnets mounted in the barrel of said housing for magnetically attracting said tool bits and for maintaining said bit assemblies separate and nested proximate the inner surface of said housing, and for guiding said bit assemblies as they are urged between the extended and retracted position.

Preferably further including a locking means for locking said tool bit in said extended position.

Preferably wherein said bit assemblies include a bit extension connected to said tool bit with a connector.

Preferably wherein said bit extension being flexible in the radial direction and stiffer in the lateral direction.

### BRIEF DESCRIPTION OF THE DRAWINGS

The invention will now be described by way of example only with references to the following drawings in which:

FIG. 1 is a partial exploded perspective schematic view of the driver

FIG. 2 is an assembled perspective schematic view of the multi-bit driver.

FIG. 3 is a perspective schematic view of the bit cartridge.

FIG. 4 is a top plan view of the multi-bit driver.

FIG. 5 is an end view of the multi-bit driver shown in FIG. 4.

FIG. 6 is an end view of the multi-bit driver shown in FIG. 4.

FIG. 7 is a bottom plan view of the multi-bit screw driver.

FIG. 8 is a top plan view of the multi-bit driver.

FIG. 9 is a cross-sectional view of the multi-bit driver shown in FIG. 8, taken along lines 9-9.

FIG. 10 is cross-sectional view of the multi-bit driver shown in FIG. 8, taken along lines 10-10.

FIG. 11 is a partial exploded perspective view of the multi-bit driver.

FIG. 12 is a top plan view of the bit assembly.

FIG. 13 is a side plan view of the bit assembly.

FIG. 14 is a partial cut away view of the multi-bit driver showing the relationship of the bit assemblies of the barrel.

FIG. 15 is a cross-sectional view of the multi-bit driver shown in FIG. 8 taken along lines 15-15.

FIG. 16 is a cross-sectional view of the multi-bit driver taken along lines 16-16 of FIG. 8.

FIG. 17 is a partial exploded perspective schematic view of the presently preferred embodiment of the multi-bit driver.

FIG. 18 is a perspective schematic view of the presently preferred embodiment of the bit cartridge.

FIG. 19 is a top plan view of the bit assembly of the presently preferred embodiment.

FIG. 20 is a side plan view of the bit assembly of the presently preferred embodiment.

FIG. 21 is a partial cut away view of the presently preferred embodiment multi-bit driver showing the relationship of the bit assemblies and the barrel.

FIG. 22 is a top plan view of the presently preferred embodiment of the multi-bit driver.

FIG. 23 is a cross sectional view of the presently preferred multi-bit driver shown in FIG. 22 taken along lines 23-23.

FIG. 24 is a cross sectional view of the presently preferred multi-bit driver shown in FIG. 22, taken along lines 24-24.

### DETAILED DESCRIPTION OF THE PREFERRED EMBODIMENT

Definition: Tool bits come in a variety of lengths and are normally made of hardened steel and have an hexagonal profile with a variety of driver heads such as Robertson, Phillips, Torx and Allen etc.

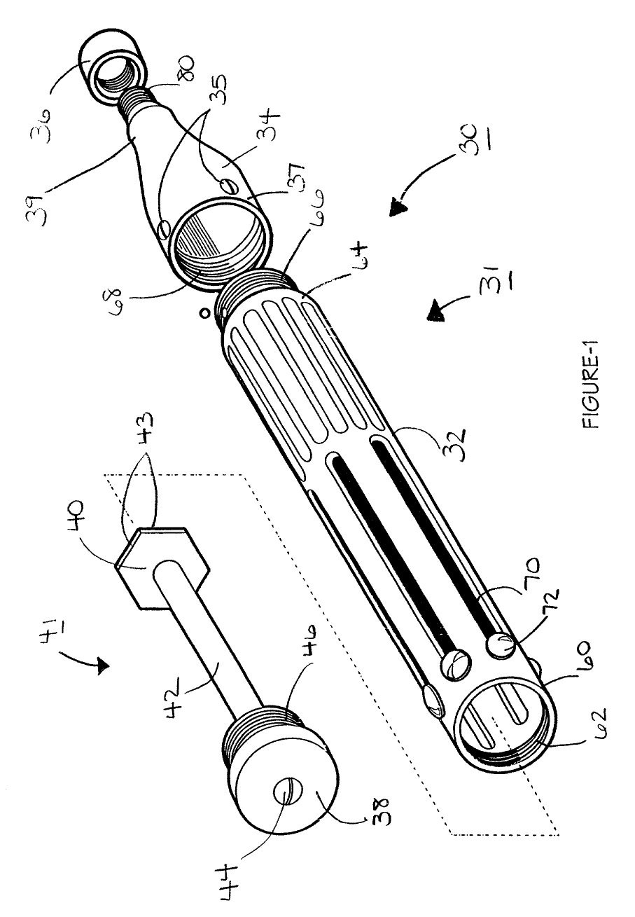

The present invention, a multi-bit driver shown generally as 30 includes the following major components which are depicted in FIGS. 1, 2 and 3. Multi-bit driver 30 includes housing 31, cone 34, collar 36, bit cartridge 50 which includes bit guide 41.

Referring now to FIG. 1, which is partial exploded view of multi-bit driver 30, housing 31 includes barrel 32, actuator channel 70, actuator knobs 72, external threads 66, proximate cone end 64 and threads 62, proximate cap end 60.

Housing 31 further includes cone 34 having externally threaded bit chuck 80 at chuck end 39, internally threaded collar 36, threadably engaging with bit chuck 80, internal threads 68, proximate barrel end 37 as well as locking screws 35.

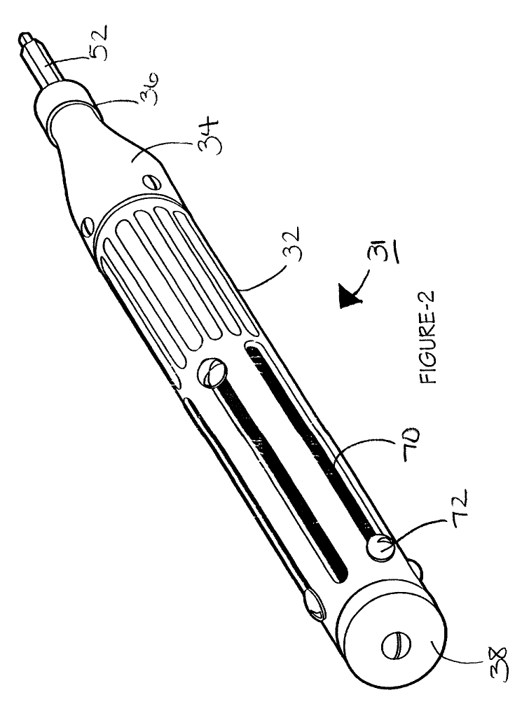

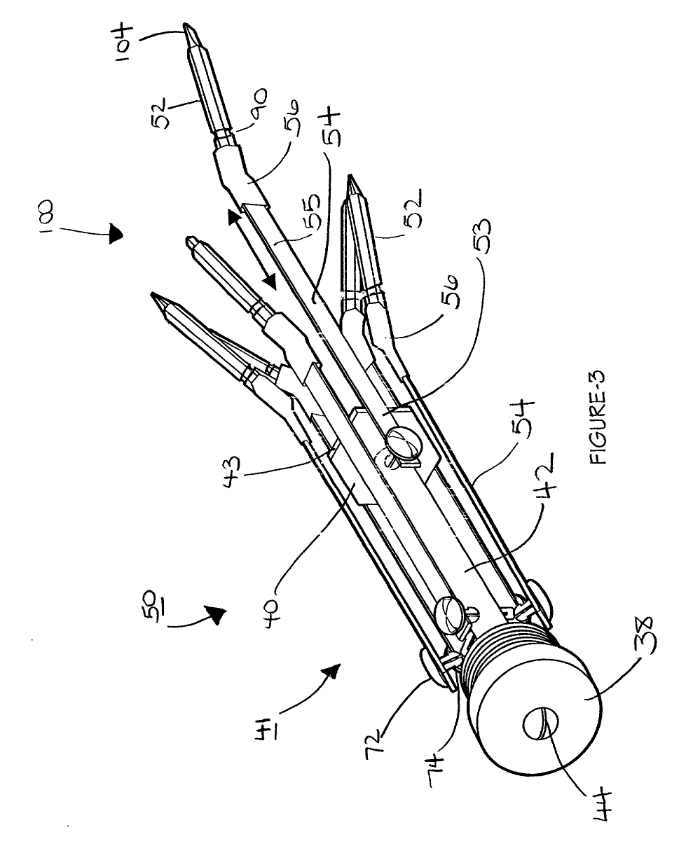

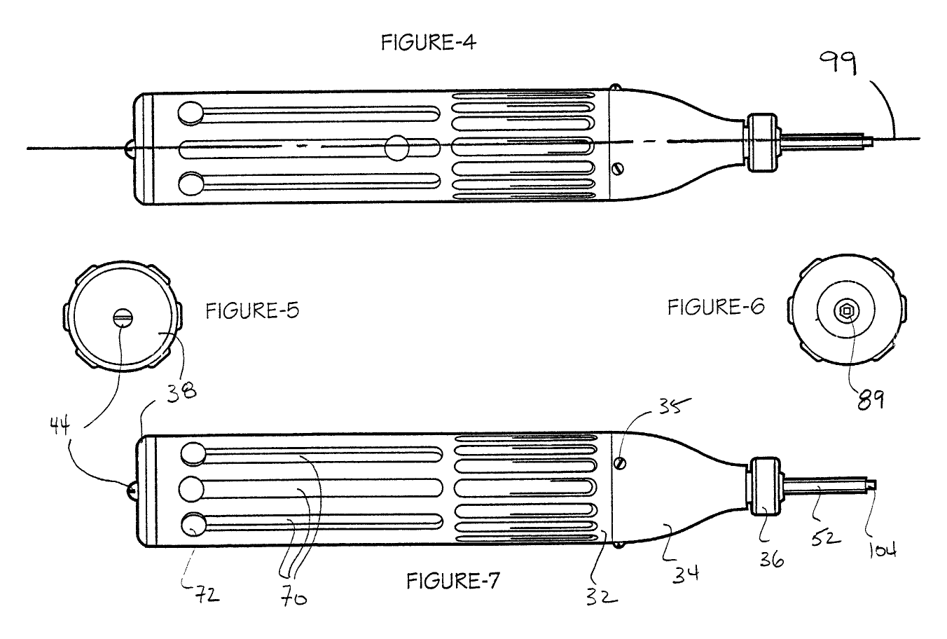

Bit cartridge 50 shown best in FIG. 3 is made up of two major assemblies, namely bit guide 41 which is shown on FIG. 1 and bit assembly 100.

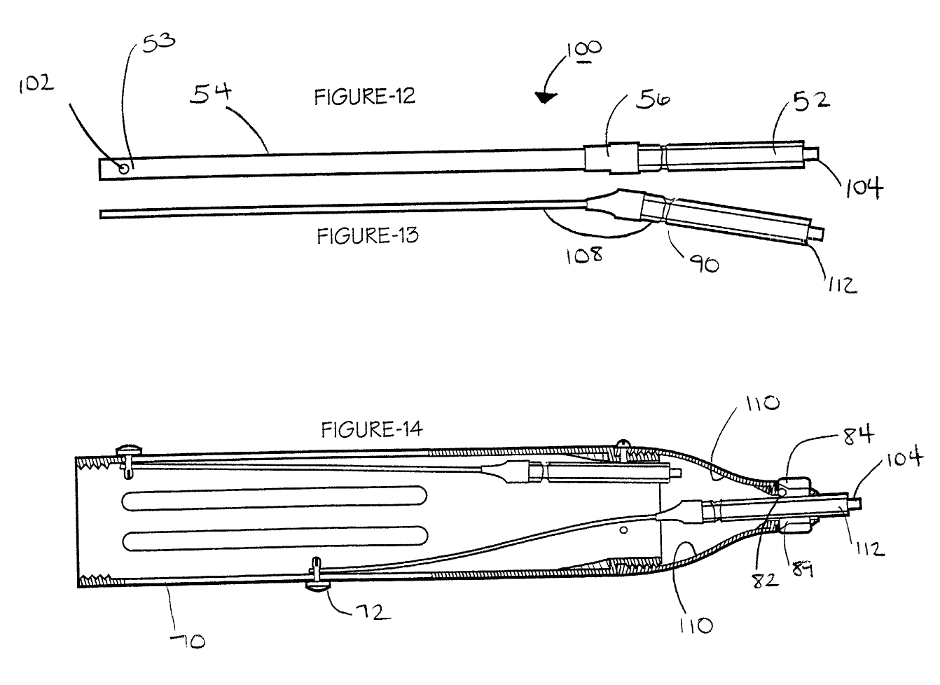

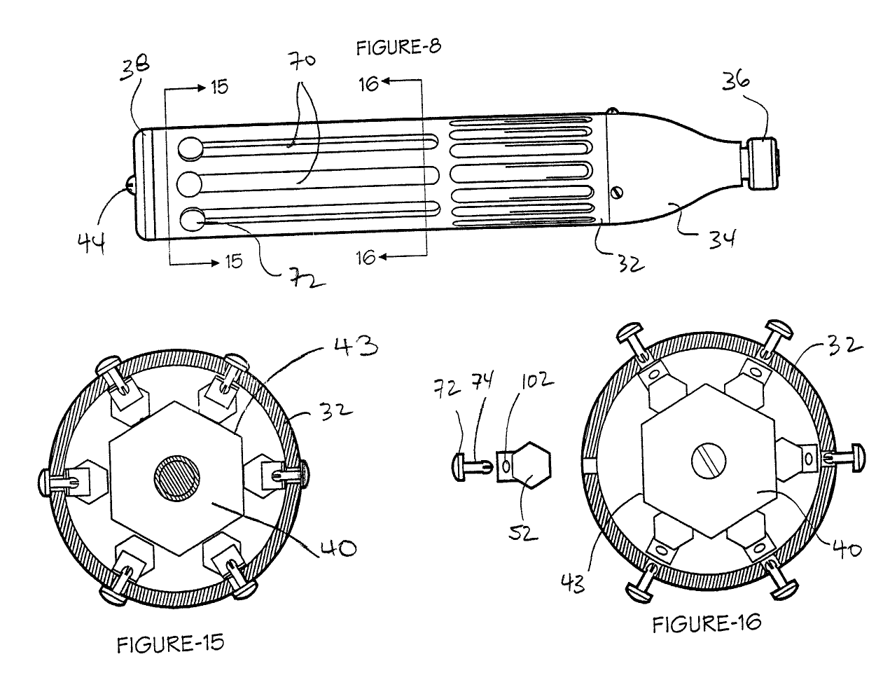

As best viewed in FIGS. 3, 12 and 13, bit assembly 100 includes bit extension 54, with a fastener aperture 102, proximate fastener end 53 and a tool bit 52 connected to bit extension 54 with connector 56. Tool bit 54 is of the type commercially available in the market place and normally would have a locking groove 90 at one end and a driver head 104 at the other end. As depicted in FIGS. 1, 2 and 3, bit cartridge 50 contains six bit assemblies 100 in this particular arrangement. Fewer or more bit assemblies could be utilized simply by scaling up or down the geometry shown in FIGS. 1, 2 and 3. In practise, the size of multi-bit driver 30 will limit the upper limit of bit assemblies 100 that are practically feasible in using in multi-bit driver 30 since there are many different driver heads 104 currently on the market, a minimum of four bit assembly 100 seems to be the lower practical limit for the number of driver heads. Having said that, however, there is no reason why multi-bit driver 30 could not be made with only one or two bit assemblies 100 and upwards of 12, 16 or 20 bit assemblies 100 except for practicalities of size and function of multi-bit driver 30.

Bit guide 41 is best seen in FIG. 1, includes guide support 42 having connected at one end thereof guide 40 and at the other end, end cap 38 having a screw 44 connecting guide support 42 to cap end 38, wherein cap end 38 has cap threads 46 which are threadably received by threads 62 of cap end 60 of barrel 38. Bit assemblies 100 are connected to barrel 32 via actuator knob 72 having integrally connected therewith a knob fastener portion 74 for slidably fastening bit assembly 100 to barrel 32 through an actuator channel 70.

Guide 40 has in this case six guide faces 43 for receiving slidably thereon bit extension 54 each of which rest on a guide face 43 and can be slidably moved along guide face 43, as actuator knob 72 is urged along actuator channel 70.

Assembly

Firstly bit assembly 100 is assembled together by fastening bit extension 54 to tool bit 52 using a connector 56. As shown in the attached diagram connector 56 is a shrink wrap type material that is commercially available which upon applying heat shrinks onto the portion which is within the shrink wrap itself. This is only one method of connecting tool bit 52 to bit extension 54. Many other methods known in the art can be equally successfully used. Particularly is contemplated molding bit extension 54 which is normally made of a flexible plastic material directly into one end of tool bit 52 which is normally made of a hardened steel material.

In order for multi-bit driver 30 to work properly, bit assemblies 100 must have certain properties. Firstly, bit extension 54 must be made of a resiliently flexible material which allows for elastic bending of bit extension portion 54. In this regard, many plastics are suitable including poly propylene, nylon, TEFLON, vinyl and like plastic materials. Secondly, bit extension preferably has memory properties which ensures that tool bit 52 is always delivered to bit chuck 80 in similar orientation to ensure it is aligned properly and is slidably received through bit chuck 80. It is also possible to use metals including spring steel and/or spring aluminum as possible materials for bit extension 54. As already mentioned, connector 56 is of a shrink wrap type, however, directly molding bit extension 54 to tool bit 52 and/or integrally manufacturing bit extension 54 together with tool bit 52 is also a possibility, particularly if both bit extension 54 and tool bit 52 are made of the same material.

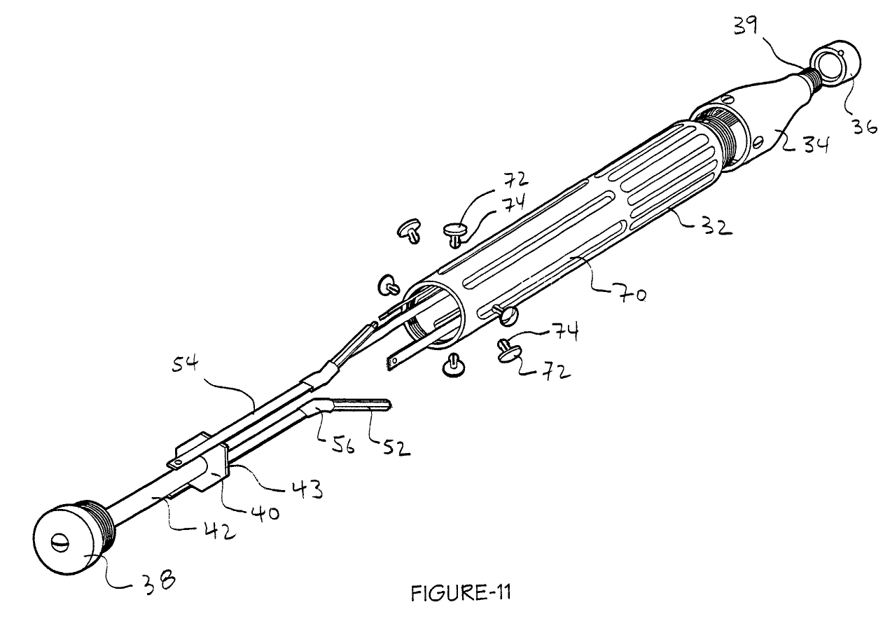

As best shown in FIG. 11 once bit assemblies 100 have been assembled, they are loaded into barrel 32 as shown in FIG. 11. Bit assemblies 100 are urged through cap end 60 of barrel 32 and are longitudinally aligned with an actuator channel 70 in barrel 32. In this manner, bit assemblies 100 are nested etui distant around the interior circumference of barrel 32 and in this case 6 bit assemblies are shown to be inserted into barrel 32. Note that preferably each bit assembly 100 has a slight angular bend namely angle theta 108 as shown in FIG. 13. At connector 56 where tool bit 52 is connected with bit extension 54, the angle theta is approximately 20° which has been found to work best in practise. Angle theta 108 can range from 1° to 45°, however, the preferred angle is 20°. Angle theta 108 is incorporated into bit assembly 100 in order to keep head end 112 of bit assemblies 100 proximate the inner diameter of barrel 32 and to prevent tool bit 52 from impinging on one another while loaded in barrel 32. Angle theta 108 is also required to ensure tool bit 52 is aligned longitudinally with receiving channel 89 when it enter bit chuck 80. From FIGS. 3 and 11 you will see that assemblies 100 are installed into barrel 32 such that the head end 112 of tool bits 52 are projecting outwardly toward to the interior diameter of barrel 32.

Once bit assembly 100 has been inserted far enough into barrel 32 such that fastener aperture 102 lines up with an actuator channel 70, bit assembly 100 is then slidably fastened to barrel 32 by inserting an actuator knob 72 having a knob fastener 74 which as shown is of the split collar type, in order to fasten bit assembly 100 to barrel 32. Note that bit assembly 100 is free to slidably move along actuator channel 70 by urging knob fastener 74 longitudinally upward or downward along actuator channel 70. Knob fastener 74 of actuator knob 72 passes through actuator channel 70 defined in barrel 32, as well as through fastener aperture 102 defined in bit extension 54, wherein fastener aperture 102 is dimensioned so that as fastener 74 passes through fastener aperture 102 it locks extension 54 to knob fastener 74.

Once bit assemblies 100 are in place, and fastened into placed with knob fastener 74, bit guide 41 can now be inserted through cap end 60 of barrel 32. Guide 40 is connected to guide support 42 in such a manner so as to allow guide 40 to rotate independently of guide support 42 while threading end cap 38 into threads 62 at cap end 60.

With guide 40 in place, the bit extension 54 of bit assemblies 100 are in slide able engagement with guide faces 43 of guide 40 as they are urged along actuator channel 70. Guide 40 serves to maintain bit extension 54 in their proper position longitudinally aligned with actuator 70 and also ensures to keep bit assemblies 100 nested outwardly adjacent the inner diameter of barrel 32.

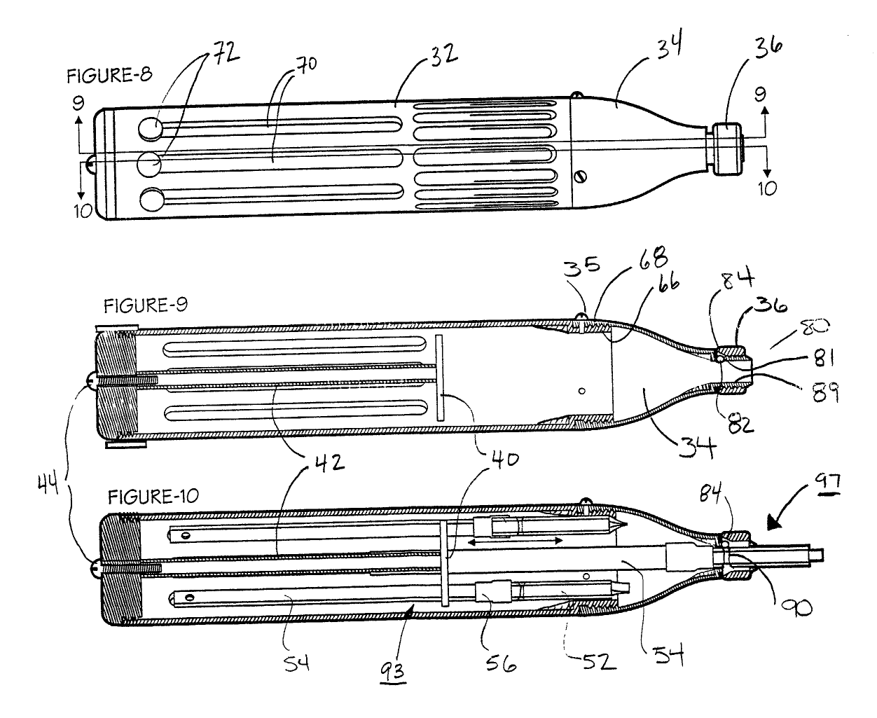

As best shown in FIGS. 9 and 10, cone 34 can now be threadably installed onto external thread 66 of barrel 32 and subsequently locking screw 35 can be installed to ensure that cone 34 does not rotate or turn on external thread 66 but rather remains in a stationary position.

Once cone 34 is in place, steel ball 82 is placed into a counter sink 81 located in bit chuck 80 and collar 36 is threadably attached to chuck end 39 until tapered surface 84, makes contact with steel ball 82. This completes the assembly of multi-bit driver 30.

In Use

As best shown in FIGS. 10 and 14, multi-bit driver 30 is utilized as follows. With all of the six bit assemblies 100 installed into barrel 32 and nested equally around the interior circumference of barrel 32, tool bit 52 can be selected from retracted position 93 for use by slidably urging actuator knob 72 longitudinally along actuator channel 70.

As shown in FIG. 14 as actuator knob 72 is moved with simple finger pressure longitudinally along actuator channel 70 such that, head end 112 and/or driver head 104 of tool bit 52 makes contact with guide surface 110 of cone 34. Tool bit 52 is guided into and enters chuck receiving channel 89. As actuator knob 72 continues to be urged upwardly along actuator channel 70, tool bit 52 slidably moves along guide surface 110 thereby flexing bit extension 54 as tool bit 52 moves closer to chuck receiving channel 89. Finally, tool bit 52 enters chuck receiving channel and is aligned with longitudinal axis 99 of housing 31. Tool bit 52 should be substantially aligned longitudinally with housing 32 in order to be able to usefully employ multi-bit driver 30.

Tool bits 52 normally have an exterior hexagonal profile and chuck receiving channel 89 has a cooperating hexagonal opening. The flat longitudinally aligned bit extension sliding along guide faces 43 on guide 40 serve to align tool bit 52 exactly with chuck receiving channel 89 such that tool bit 52 is easily and slidably received within chuck receiving channel 89 anytime it is urged towards chuck receiving channel 89.

By continuing to urge knob fastener 74 upwardly, tool bit 52 passes through chuck receiving channel 89 until locking groove 90 aligns with steel ball 82 located in counter sink 81 in bit chuck 80. At this point tool bit 52 is aligned with longitudinal axis 99, and is in the extended position 97.

In order for tool bit 52 to slidably and easily pass through receiving channel 89, collar 36 is eased off and/or threadably moved forward along bit chuck 80, such that tapered service 84 does not contact steel ball 82 and is free to move upwardly within countersink 81.

Once locking groove 90 aligns with steel ball 82, collar 36 is threadably engaged and rotated onto bit chuck 80 until tapered surface 84 of collar 36 engages with steel ball 82 forcing it downwardly into countersink 81 so that steel ball 82 makes contact with locking groove 90, thereby locking tool bit 52 rigidly and securely into chuck receiving channel 89.

At this point, tool bit 52 is ready to be used and driver head 104 can be pushed and urged against any fastener head in the traditional manner.

To select another tool bit 52, collar 36 is threadably eased away from steel ball 82, thereby allowing steel ball 82 to move upwardly within countersink 81, thereby releasing steel ball 82 from locking groove 90 and tool bit 52. Actuator knob 72 is urged backwardly along actuator channel 70 retracting tool bit 52 back into barrel 32 of housing 31.

Subsequently another tool bit 52 can be selected in the same manner described above and urged forwardly up actuator channel 70 to be put into the working position in chuck receiving channel 89 as described here above.

Description of the Presently Preferred Embodiment

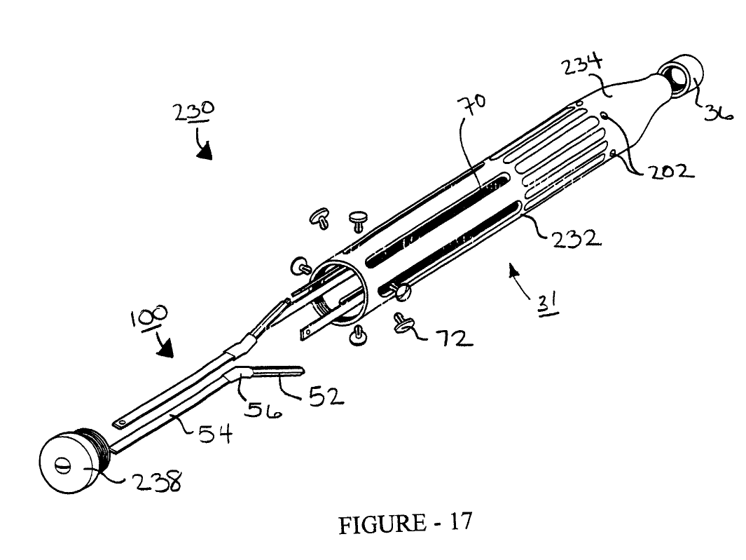

Referring now to FIGS. 17 through 24 which depict the presently preferred embodiment namely, multi-bit driver 230, the concept of multi-bit driver 230 is analogous to the concept of multi-bit screw driver 30 with some modifications as will be described here below.

Referring first of all to FIG. 17, multi-bit driver 230 includes the following major components, namely barrel 232, cone 234 having collar 36, actuator knob 72, end cap 238 and bit assemblies 100 including bit extension 54, connector 56 and tool bit 52. Note that this presently preferred embodiment, namely multi-bit driver 230 has eliminated the bit guide 41, comprising of guide 40 and guide support 42. Bit guide 41 functions to maintain bit assemblies 100 nested circumferentially equally around the inner portion of barrel 32 and to keep the bit assemblies 100 nicely separated within barrel 32. Bit guide 41 has essentially been replaced with magnets 202 which are located as shown in the FIGS. 17-24.

Referring to FIGS. 18, one will see that the presently preferred bit cartridge 250 includes end cap 238, actuator knob 72, bit extension 54, connector 56, tool bit 52 and has eliminated bit guide 41 which is comprised of guide 40 and guide support 42.

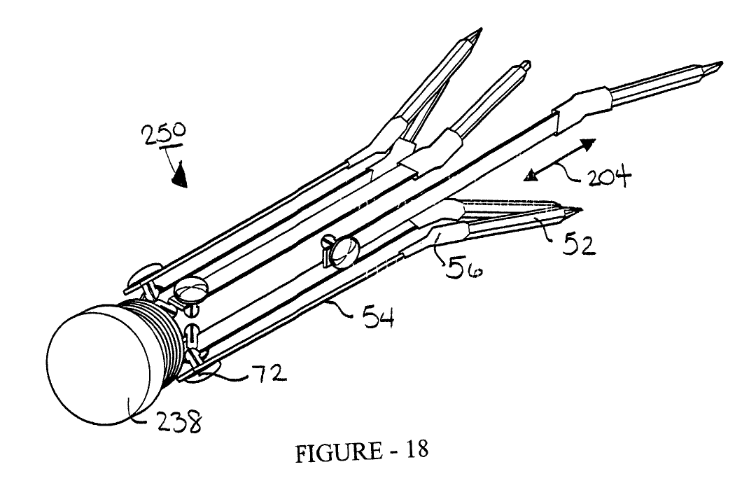

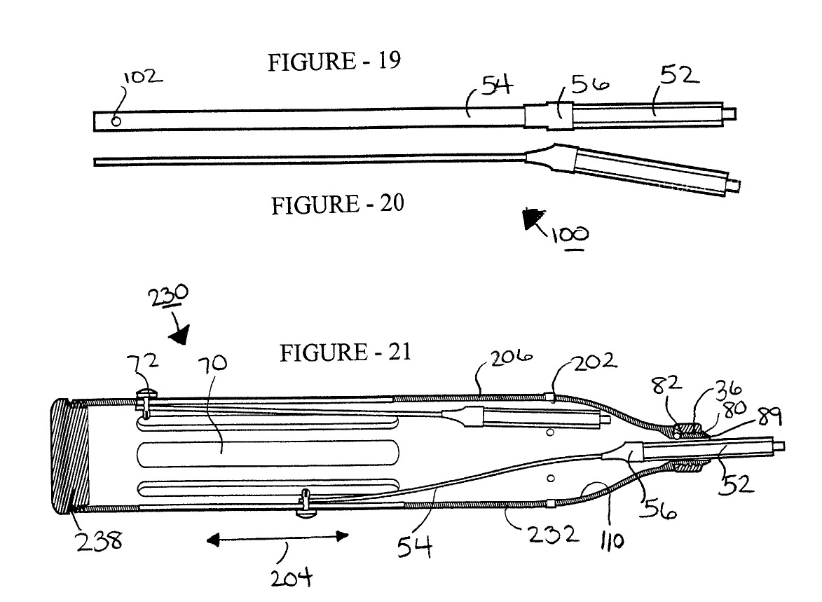

Referring now to FIGS. 19 and 20 which illustrate bit assembly 100 which remains essentially unchanged being comprised of bit extension 54, connector 56 and tool bit 52 and having a fastener aperture 102 in one end of bit extension 54.

Referring now to FIG. 21, showing schematically the bit assemblies 100 located within barrel 232, I will now explain the difference in operation between the current multi-bit driver 230 and the previous multi-bit screw driver 30.

Referring now to FIG. 21, bit assembly 100 is urged along longitudinal direction 204 by applying finger pressure to actuator knob 72 which is operatively connected to the fastener aperture 102 of bit extension 54. As actuator knob 72 is urged along actuator channel 70, it in turn urges tool bit 52 longitudinally along the inside of barrel 232 until tool bit 52 exits out of bit chuck 80 of barrel 232. One skilled in the art will notice that bit extensions 54 are flexible in one direction and therefore, conforms to forces in that direction imparted upon bit extension 54. Bit assembly 100 is kept nested along barrel wall 206 by the attraction forces between magnets 202 and metallic tool bit 52 as it is being extended and retracted out of barrel 232. Magnets 202 preferably are of the permanent magnet type. Looking to FIG. 21 for example, the upper bit assembly 100 is nested closely to barrel wall 206 because of the attraction between tool bit 52 of bit assembly 100 and magnet 202. In this manner as the bit assemblies are extended and retracted out of barrel 232, they are kept separate and apart and kept from interfering with each other because of the attraction caused by magnet 202 with each individual tool bit 52. There is an individual magnet 202 for each individual tool bit 52 being placed in barrel 232. As discussed above, preferably there are six tool bits 52, meaning 6 bit assemblies 100 nested around the inner diameter of barrel 232 which must be kept separate and apart and prevented from interfering with each other as they are being extended and retracted. In every other manner, multi-bit driver 230 operates in the same manner as multi-bit screw driver 30 does as described above. The major differences being that the bit guide 41 is no longer present, namely former parts guide 40 and guide support 42 are no longer necessary and have been replaced by magnets 202.

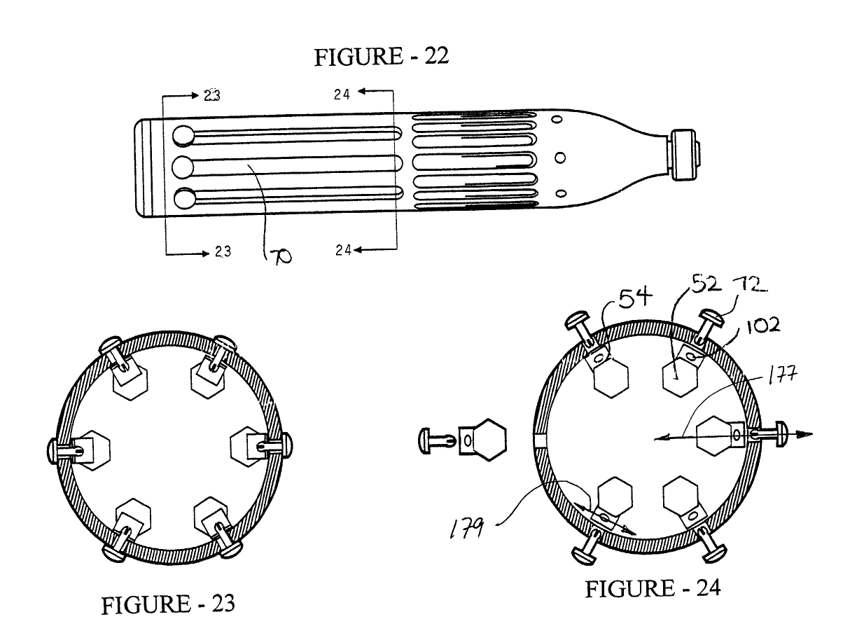

Referring now to FIGS. 23 and 24 which are cross-sectional view taken along 23-23 of FIG. 22 and 24-24 of FIG. 22 respectively, one will see that the bit guide 41 components, namely guide 40 and guide support 42, are no longer present within the interior of barrel 232 as in the previous embodiment, namely multi-bit screw driver 30. Bit extension 54 is flexible in radial direction 177 and stiffer in lateral direction 179.

Furthermore, it will be understood by persons skilled in the art that bit assembly 100 as shown comprised of three major components, namely bit extension 54, connector 56 and tool bit 52, may in fact be manufactured from one single integral piece. For example, bit assembly 100 may be made of one continuous metal component having a flexible end corresponding to bit extension 54 which is flattened and has spring like qualities and not requiring any kind of a connector 56 in that the bit extension 54 and the tool bit 52 are integrally made of one component. In addition, there are any number of other combinations that are possible to produce bit assembly 100, the important factor being that the bit extension 54 section being flexible in nature in order that it can move along the interior portion of cone 34 as the bit assembly 100 is urged longitudinally along longitudinal direction 204.

Preferably, bit assembly 100 is flexible in the radial direction and not flexible in the lateral direction to prevent interference of the bit assemblies with each other within barrel 232. Therefore, the preferred flat cross sectional shape of bit extension 54 as shown in the Figures.

Bit assembly 100 must be flexible enough to allow tool bit 52 to move along the inner surface of cone 234 and/or cone 34 in order that tool bit 52 would enter into receiving channel 89 of bit chuck 80 of cone 234 or 34. The bit extension 54 of bit assembly 100 must, however be stiff enough to urge the tool bit 52 through the receiving channel 89.

It should be apparent to persons skilled in the arts that various modifications and adaptations of this structure described above are possible without departure from the spirit of the invention the scope of which defined in the appended claim.

I claim:

1. A multi-bit driver comprising:
(a) a longitudinally oriented housing including a bit chuck at one end;
(b) a plurality of tool bits nested within said housing in a retracted position; and
(c) an actuating means for selectively extending tool bits to an extended position and retracting said tool bits to said retracted position, such that in the extended position, said tool bits project from said bit chuck and are substantially longitudinally aligned with said housing.

2. The multi-bit driver claimed in claim 1, wherein said actuating means including said tool bits and being operable to extend said tool bit from said retracted position to said extended position by a single longitudinal motion of said actuating means.

3. The multi-bit driver claimed in claim 2, wherein said longitudinal motion is effected using a single finger or thumb pressure.

4. The multi-bit driver claimed in claim 1, wherein said actuating means connected to said tool bits being operable to retract said tool bits from said extended position to said retracted position by a single longitudinal motion of said actuating means.

5. The multi-bit driver claimed in claim 4, wherein said longitudinal motion is effected using a single finger or thumb pressure.

6. The multi-bit driver claimed in claim 1, wherein said actuating means operates to extend said tool bit by longitudinal motion in one direction and retract said tool bit by longitudinal motion in the opposite direction.

7. The multi-bit driver claimed in claim 6, wherein said longitudinal motion is effected using a single finger or thumb pressure.

8. The multi-bit driver claimed in claim 1, wherein said actuator means further includes at least one bit assemblies having a flexible bit extension connected to each of said tool bits, said bit extensions for operatively urging said tool bits between said extended and retracted position and for aligning said tool bits with said bit chuck.

9. The multi-bit driver claimed in claim 8, wherein said actuating means further includes at least one longitudinally aligned actuator channels defined in said housing corresponding to each bit assembly for guiding said bit assemblies slidably along a longitudinal direction.

10. The multi-bit driver claimed in claim 9, further including a fastening means slidably connecting said bit assemblies to said actuator channels such that said bit assembly is guided slidably along said actuator channel.

11. The multi-bit driver claimed in claim 10, wherein said fastening means comprises an actuator knob partially projecting externally of said housing for the application of finger pressure thereto, said actuator knob also for connecting a fastener end of said bit assembly to said actuator knob for operatively urging said bit assembly slidably along said actuator channel.

12. The multi-bit driver claimed in claim 1, wherein said housing including a cone proximate said bit chuck having an interior guide surface for slidably guiding tool bits into alignment with said bit chuck as tool bits are urged into said extended position.

13. The multi-bit driver claimed in claim 1, further including a guide means for maintaining said bit assemblies separate and nested proximate the inner surface of said housing, and for guiding said bit assemblies as they are urged between the extended and retracted position.

14. The multi-bit driver claimed in claim 13 wherein said guide means includes permanent magnets mounted in the barrel of said housing for magnetically attracting said tool bits and for maintaining said bit assemblies separate and nested proximate the inner surface of said housing, and for guiding said bit assemblies as they are urged between the extended and retracted position.

15. The multi-bit driver claimed in claim 1, further including a locking means for locking said tool bit in said extended position.

16. The multi-bit driver claimed in claim 8, wherein said bit assemblies include a bit extension connected to said tool bit with a connector.

17. The multi-bit driver claimed in claim 16, wherein said bit extension being flexible in the radial direction and stiffer in the lateral direction.
